(19) United States
(12) Patent Application Publication
(10) Pub. No.: US 2013/0076502 A1
(43) Pub. Date: Mar. 28, 2013

(54) Method to remind drivers that there is a child / pet inside of vehicle

(71) Applicant: Jason Kahng, Toronto (CA)

(72) Inventor: Jason Kahng, Toronto (CA)

(21) Appl. No.: 13/247,685

(22) Filed: Sep. 28, 2011

(51) Int. Cl. B60Q 1/00

(52) U.S. Cl. 340/457

(57) ABSTRACT

This unique method to remind drivers that there is a child/pet inside of vehicle consists of two cues, one visual and one physical. The visual serves as a constant reminder while the driver is in the vehicle. The physical cue reminds the driver at end of the trip. The two cues work together to create a simple yet effective reminder that there is a child/pet still inside the vehicle.

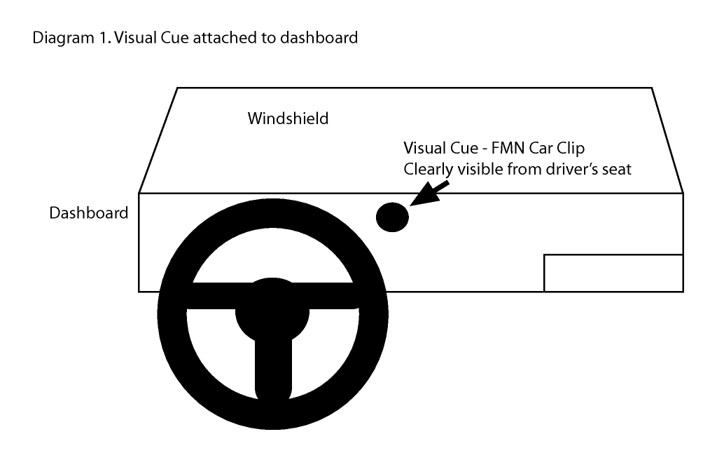

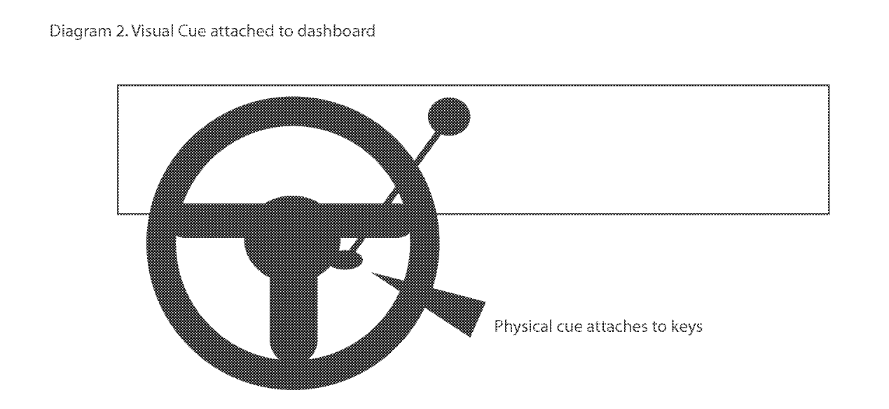

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

This method helps people to remember that there is a child/pet in their vehicle. As surprising as it may sound, there have been many unfortunate cases every year where people have forgotten a child in the vehicle. These unfortunate people include a Police Officer, an accountant, an electrician, a college professor . . . Temperatures inside a parked vehicle can get extremely hot or cold in just a few minutes placing the forgotten child/ pet in extreme danger. There were 49 cases of child deaths due to being left in the car in 2010 alone according to San Francisco State University. Most of the children were 3 years old or younger. An excellent history of the problem can be found in the Pulitzer Prize winning article by Gene Weingarten of the Washington Post called ‘Fatal Distraction’.

### BRIEF SUMMARY OF THE INVENTION

This invention is a unique method to remind drivers that they have a child/pet in the vehicle. The inside of a parked vehicle can become a deadly place in a very short period of time as temperatures can exceed 122 degrees in just a few minutes. The uniqueness of the invention is that it has both a visual and physical cue to help drivers remember there is a child/pet in the vehicle.
1. Visual cue: A device is permanently attached to the dashboard of a vehicle in a spot visible from the driver's seat. This serves as a constant reminder while the driver is in the vehicle that there may be a child/pet in the vehicle.
2. Physical cue: Upon entering a vehicle and having placed the child/pet in the back, the driver physically attaches part of the device to the car keys. Upon arrival at destination, driver cannot remove keys from vehicle without the physical reminder that there is a child/baby in the vehicle.

### BRIEF DESCRIPTION OF THE SEVERAL VIEWS OF THE DRAWING

Diagram 1 is of a visual cue that is permanently attached to the dashboard of the vehicle in a place very visible from the driver's seat and close to the ignition. The device serves as a constant reminder that there may be a child/pet in the vehicle.

Diagram 2 shows how one end of the device is attached to the car keys when there is a child/pet in the vehicle to create a physical reminder when the driver arrives at the destination. The driver cannot remove their car keys without being reminded there is a child/ pet still in the vehicle.

### DETAILED DESCRIPTION OF THE INVENTION

This invention is a unique method to remind a driver that a child/ pet is in the vehicle. No other known device has the combination of both visual and physical cues to remind drivers that there is a child/ pet in the vehicle.

Visual cue—a preferably bright and very distinct object is permanently fastened to the vehicle's dashboard in a place very visible from the driver's seat. It should be very noticeable so as to serve as a reminder—but it should neither obstruct vision nor physical movements (eg. changing radio dial, adjusting mirror, driving). E.g. a device in the shape of a purple flower with an illustration of a teddy bear in the center may serve well as a reminder that there may be a child in the car. A black rectangular object may not be a good visual cue as it may blend in too easily into the usually dark dashboards of vehicles. The object should be large enough to be clearly visible from the driver's seat (e.g. at least 1″ square/diameter) but shouldn't be too large that it obstructs driver's use of controls (e.g. shouldn't be 12″×12″ as this might hinder driver's adjusting of certain dials/controls in vehicle and may also hinder safe driving). The fastening of the object to the dashboard should be strong enough to withstand the wide range of temperatures and physical movements associated with normal use of the vehicle. The visual cues may also have reflective or glowing or illuminating qualities that may enhance the effect.

Physical Cue—a string-like device that the driver attaches the to the car key/keychain/key holder. One end is attached to the visual cue. The other end attaches to the driver's ignition key/keychain. Preferably retractable so as to not disturb the driver in any way, but not necessarily retractable. Physical cue must be long enough to attach easily to the keys yet short enough that it doesn't affect driver movement. Length of the physical cue should be about the shortest distance between the visual cue and the keys (as opposed to being able to be wrapped around the steering wheel 2 times before attaching to the keys) plus what is necessary for easy attachment to keychain (may be clip/some other fastening device or the string itself). The physical cue should not change in length due to the movements in the vehicle. As driver gets adept at removing physical cue when arriving at destination (e.g. removes clip without being reminded), driver can make physical cue more complicated (e.g wrap string around keychain multiple times rather than just once before attaching) so the release is not automatic and reminder is there.

How it is used:

At first, the visual cue/ object is permanently attached to the vehicle's dashboard. Subsequently, every time a driver has a child/ pet in the vehicle, the driver attaches the physical cue (which has one end attached to the visual cue) to the car keys/ keychain when child/pet is in the vehicle. Start vehicle and drive to destination. At destination, the driver cannot remove the car keys without the physical cue reminding the driver that the child/ pet is still in the vehicle.

Why this invention is better than other devices used to alert drivers of children in back of vehicle: Unlike other methods, this method has no mechanical parts that can fail, no electronic components that are interfered with, may have no batteries to replace nor power cords to attach, not difficult assemble/attach, and has two cues that a child is on board (whereas most other methods have only one). It creates almost no interference with the driver's physical movements (doesn't obstruct adjusting of dials, pushing of buttons . . . ) and the reminder can get ‘smarter’ as the driver becomes more adept at removing the physical reminder. It is also very affordable and so everyone can have one in the vehicle.

It is a simple, low cost, yet highly effective solution to a potentially fatal lapse.

1. A unique method to remind a driver that there is a child/pet in the vehicle comprised of both a visual and a physical cue. Visual cue—the device is attached to a vehicle's dashboard in a spot highly visible from the driver's seat and serves as a constant reminder that there may be a child/ pet is in the vehicle. The physical cue is the part of the device that attaches to car keys. When driver arrives at destination, s/he cannot remove keys from vehicle without the physical cue reminder that there is a child/ pet still in the vehicle.
